(19) United States
(12) Patent Application Publication
(10) Pub. No.: US 2007/0100939 A1
(43) Pub. Date: May 3, 2007

(54) Method for improving attentiveness and participation levels in online collaborative operating environments

(76) Inventors: Elizabeth V. Bagley, Cedar Park, TX (US); Pamela Ann Nesbitt, Tampa, FL (US); Amy Delphine Travis, Arlington, MA (US); Lorin Evan Ullmann, Austin, TX (US)

Correspondence Address: IBM CORP (YA);C/O YEE & ASSOCIATES PC, P.O. BOX 802333, DALLAS, TX, 75380, US

(21) Appl. No.: 11/260,581

(22) Filed: Oct. 27, 2005

(51) Int. Cl. G06F 15/16

(52) U.S. Cl. 709/204

(57) ABSTRACT

A method, system, and computer program product for improving attentiveness and participation levels in online collaborative operating environments. The mechanism of the present invention provides ways that participants can maintain their focus on the collaboration meeting by allowing participants to interact with the presentation and other participants, and determine the structure of the presentation as well. A collaboration presentation is provided to a user, wherein the collaboration presentation includes a plurality of activities, such as simple entertainment activities or interactive tasks. When a user selects a desired activity in the plurality of activities, the mechanism of the present invention provides the desired activity to the user, wherein engaging in the desired activity focuses the user on the collaboration presentation.

### BACKGROUND OF THE INVENTION

1. Field of the Invention

The present invention relates generally to an improved data processing system, and in particular, to a method for improving attentiveness and participation levels in online collaborative operating environments.

2. Description of the Related Art

Widespread use of computers-and the interconnectivity provided through networks allows for different users to collaborate or work with each other in different locations. Collaborating users may be as close as in an office down the hall or on another floor, or as far away as in another city or country. Regardless of the distance, users are able to communicate with each other and collaborate on different projects. For instance, users can communicate with each other through email and instant messages over networks, such as wide-area networks and the Internet. In addition to email and instant messaging, users may use online collaboration tools to conduct presentations and e-meetings, wherein participants may converse with each other in real-time.

A problem with online collaborative operating environments is that a participant may often lose interest, stop listening, and start doing something else during e-meetings because there is no face-to-face contact between the participant and others attending the e-meeting. In contrast, participants in face-to-face meeting environments are typically more attentive than online conferencing participants, since a participant's inattentiveness in a face-to-face meeting may be easily noticed by others. Thus, while inattentive participants in a face-to-face environment may appear rude or suffer repercussions for their actions, there are fewer pressures of this kind in an online collaborative environment. For example, an all-too-common problem with online conferencing as a learning environment is that too many students “lurk”, or watch what is going on in the conference, without becoming actively involved in the discussion.

There are some features in existing systems that encourage interaction between participants meeting in an online collaboration environment, such as document sharing, chat sessions, screen sharing, and polling mechanisms. Common interactive methods include polling mechanisms which generally provide a user-input form and a consensus results display. The user-input form may be a combination of a question and a series of options in the form of selectable buttons associated with a descriptive text, wherein a user may select and possibly confirm a choice or preference. Other mechanisms for maintaining participant interaction employ instant messaging for communicating with the presenter or other participants in the meeting, as well as providing pre-defined drop-down lists of possible messages a participant may send to others, such as, for example, “I have a question” or “I am fine”. Selectable icons are also used to encourage interaction by allowing participants to send specific messages, such as a raised hand icon to indicate that the participant has a question, smiley face and clapping hands icons to indicate the participant's laughter or applause, or an open doorway icon that indicates that the user has stepped out of the meeting. While existing methods may be used to encourage participant interaction, these methods consist of polling the participants using canned questions and chatting with the collaboration presenter.

Therefore, it would be advantageous to have an improved mechanism for improving attentiveness and participation levels in online collaborative operating environments. It would further be advantageous to have a mechanism for keeping participants engaged in the collaboration by providing collaboration participants with control over how the participants choose to maintain focus on the collaboration presentation.

### SUMMARY OF THE INVENTION

Embodiments of the present invention provide a method, system, and computer program product for improving attentiveness and participation levels in online collaborative operating environments. The mechanism of the present invention provides ways that participants can maintain their focus on the collaboration meeting by allowing participants to interact with the presentation and other participants, and determine the structure of the presentation as well. A collaboration presentation is provided to a user, wherein the collaboration presentation includes a plurality of activities, such as simple entertainment activities or interactive tasks. When a user selects a desired activity in the plurality of activities, the mechanism of the present invention provides the desired activity to the user, wherein engaging in the desired activity focuses the user on the collaboration presentation.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a representation of a network of data processing systems in which the present invention may be implemented;

FIG. 2 is a block diagram of a data processing system in accordance with an illustrative embodiment of the present invention;

FIG. 3 is a block diagram illustrating the relationship of software components operating within a computer system in accordance with an illustrative embodiment of the present invention;

FIG. 4 is an example online collaboration display providing entertainment activities to collaboration participants in accordance with an illustrative embodiment of the present invention;

FIG. 5 is a flowchart of a process for improving participant attentiveness in an online collaboration using entertainment activities in accordance with an illustrative embodiment of the present invention;

FIG. 6 is an example online collaboration display providing interactive tasks to collaboration participants in accordance with an illustrative embodiment of the present invention;

FIG. 7 is a flowchart of a process for improving participant attentiveness in an online collaboration using interactive tasks in accordance with an illustrative embodiment of the present invention

FIG. 8 is an example online collaboration display illustrating an example adaptive question queue in accordance with an illustrative embodiment of the present invention;

FIG. 9 is a flowchart of a process for improving participation in an online collaboration using an adaptive question queue in accordance with an illustrative embodiment of the present invention;

FIG. 10 is an exemplary online collaboration display illustrating a visual notification of reward points for indicating how many times a user has interacted with the online collaboration in accordance with an illustrative embodiment of the present invention; and

FIG. 11 is a flowchart of a process for improving participation in an online collaboration using visual notification of reward points in accordance with an illustrative embodiment of the present invention.

### DETAILED DESCRIPTION OF THE PREFERRED EMBODIMENT

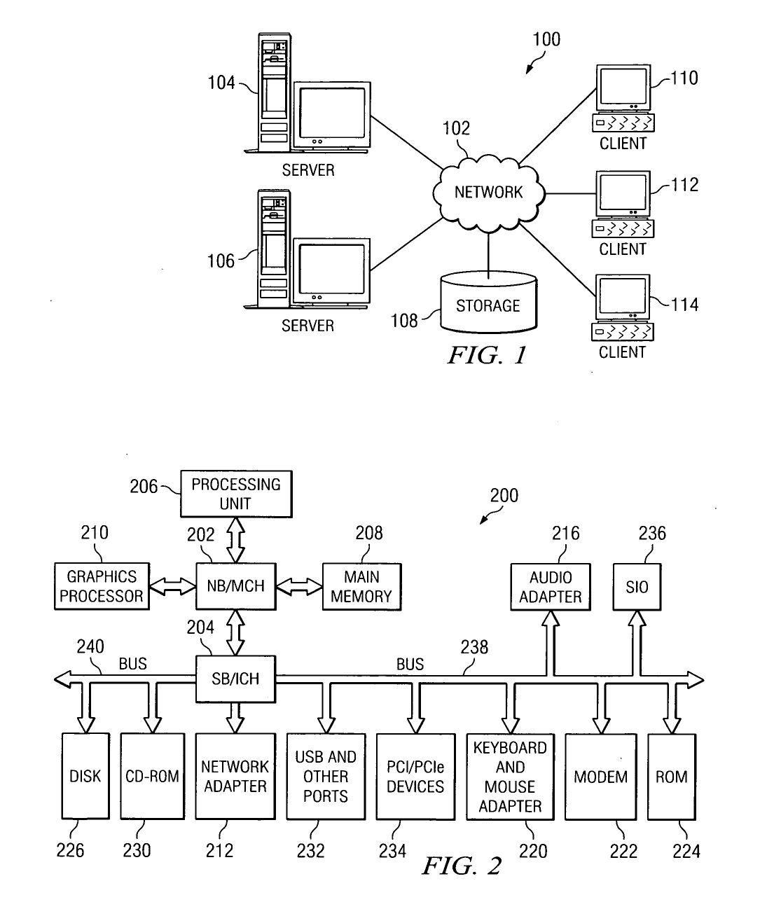

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Embodiments of the present invention provide a method, system, and computer program product for promoting attentiveness and participation in an online collaboration environment. With the mechanism of the present invention, collaboration participants may participate in activities complementary to an online presentation, beyond standard interaction methods of asking questions and chatting with the collaboration presenter. The mechanism of the present invention enhances existing methods of user interaction in collaboration environments by providing collaboration participants with control over how the participants choose to maintain focus on the collaboration presentation. These controls allow participants to augment their experiences of the meeting, such as choosing the template for the presentation to be shown, submitting a marked-up copy of the presentation, viewing their comments/questions as the comments/questions are queued up for the presenter, specifying when a coffee break should occur, etc. Thus, the mechanism of the present invention provides ways that participants can maintain their focus on the meeting by allowing participants to interact with the presentation and other participants, and determine the structure of the presentation as well.

One embodiment of the present invention provides a variety of simple entertainment activities to collaboration participants, such as interactive games. Simple entertainment activities may include activities for a single participant, as well as activities that allow multiple collaboration participants to interact with each other during the presentation. The mechanism of the present invention allows each participant to select the type of simple entertainment activity to be used to maintain the participant's interest in and focus on the presentation. Simple entertainment activities allow participants to interact with the online collaboration and other participants without using text, such as via an instant messaging program. Although text messaging with other participants may keep a user's focus directed to the computer display, text messaging may require too much thought on the part of the participants and cause participants to become too distracted from the meeting itself.

Another embodiment of the present invention promotes participation in the online collaboration environment by providing interactive tasks to be performed by the participants. These interactive tasks or duties allow the participants to control the structure or flow of the presentation and may complement the online meeting activities. The interactive tasks may include, for example, erasing the presentation whiteboard, determining when a break in the meeting should occur, selecting the template to be used on the slides of the presentation, receiving a token for asking the first question or asking a certain number of questions, etc.

The mechanism of the present invention also encourages participant interaction in the online collaborative environment by measuring participant involvement in the meeting and ordering the questions received from the participants according to the participants' level of interaction. Prior to the beginning of or during the meeting, participants may submit questions to the presenter. The mechanism of the present invention parses questions received from participants and queues the questions in the order received. During the meeting, the order of the questions may be reordered by the mechanism of the present invention based on the level of interaction of the participants that submitted the questions. For example, the level of participant interaction may be measured based on the number of questions a participant has submitted or the speed and frequency of the participant's response to polling questions. A participant's attentiveness to the presentation may also be measured by monitoring the participant's display to determine that the collaboration application window is the active window on the participant's screen and that no other application on the desktop is receiving keyboard or mouse input. Other monitoring devices may also be used, such as a video camera for observing the participant's movements or activities, such as the participant's phone usage.

In addition to submitting questions, the mechanism of the present invention encourages user interaction by allowing participants to submit a “marked up” version of the collaboration presentation prior to or during the meeting. For example, in a PowerPoint presentation, a participant may insert “comments” or “yellow sticky notes” onto the presentation slides. The mechanism of the presentation may parse out the inserted comments and questions and queue them up for the presenter as the comments and questions are received.

The mechanism of the present invention also comprises a reward system that awards points to users based on their participation in the meeting. The reward system of the present invention enables real-time viewing of the accumulated points as the presentation is in progress. Each participant may be represented in the online meeting by the participant's name or a persona icon. As the participant is awarded points, the accumulated points are associated with the name or persona icon of the participant and displayed to all of the meeting participants. By allowing the accumulated points to be visible to all participants in the meeting, participants may compare their activity in the meeting against one other. In this manner, a participant' attention may be periodically re-directed to the content meeting, since the participant, especially if competitive in nature, will want to check what the participant's score is in relation to the others.

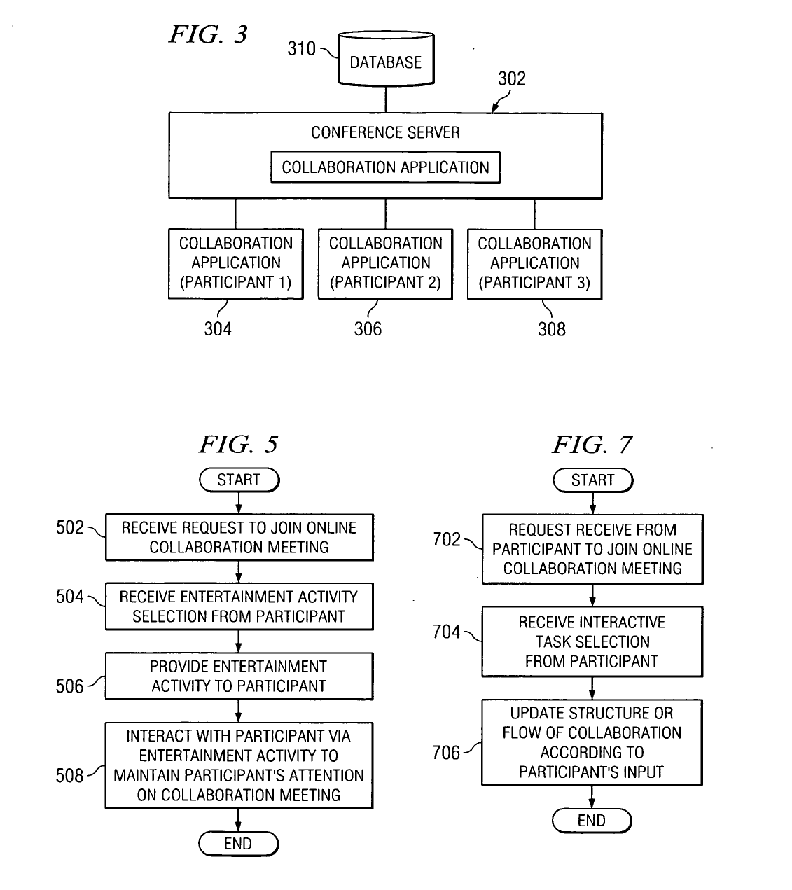

With reference now to FIG. 3, an exemplary block diagram illustrating how an online meeting may be hosted on a conference server according to an illustrative embodiment of the present invention is shown. Conference server 302 may permit one or more clients to log in to a meeting. Conference server 302 may support packet distribution of voice and video from one or more clients over network connections with each client. Conference server 302 may be implemented in a server such as server 104 or 106 in FIG. 1.

In this illustrative example, three participants are shown to have joined the meeting through client collaboration applications 304-308. Each client collaboration application may be applications operating on distinct computers, such as, for example, clients 110-114 in FIG. 1. One of the client collaboration applications may be co-resident on conference server 302, such that that conference server may operate a conference host application and a conference client application.

Conference server 302 may access database 310. Database 310 may store information concerning participants, which may be looked up with reference to a login identifier of each participant. Database 310 may be implemented in, for example, storage unit 108 in FIG. 1.

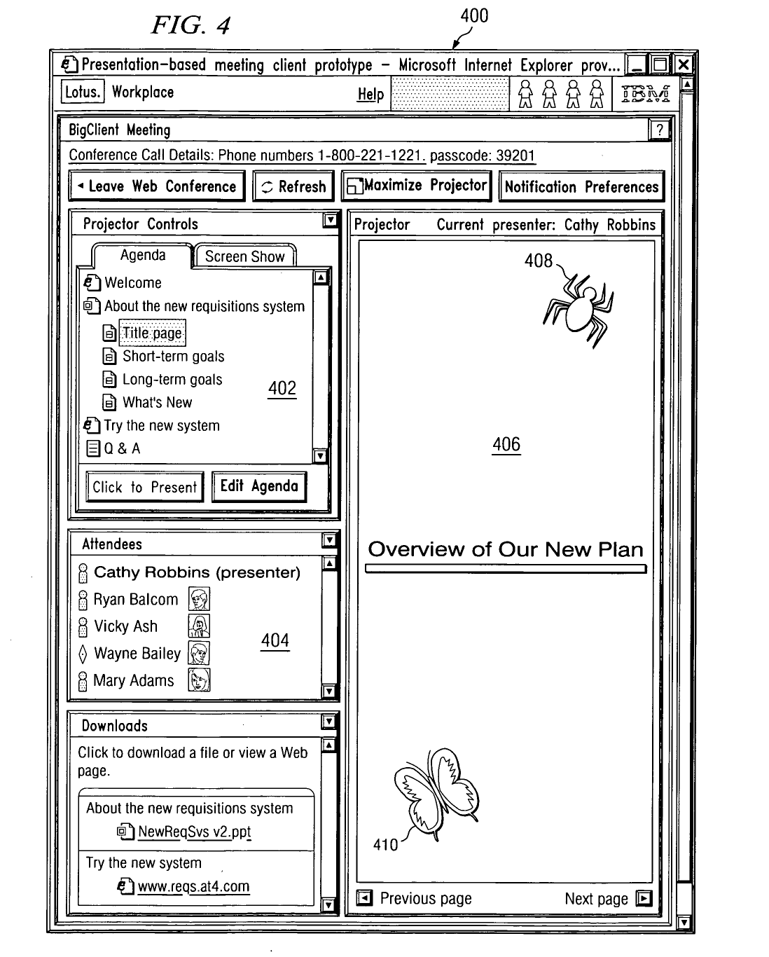

Turning now to FIG. 4, an example online collaboration display providing interactive entertainment activities to collaboration participants in accordance with an illustrative embodiment of the present invention is shown. The online collaboration display in FIG. 4 may be provided to a user via a collaboration application, such as client collaboration applications 304-308 in FIG. 3, within a data processing system, such as clients 110-114 in FIG. 1.

In this illustrative example, online collaboration display 400 depicts a presentation-based meeting as viewed by a participant of the meeting. As shown, online collaboration display 400 may comprise a schedule of the presentation-based meeting, such as agenda 402. Online collaboration display 400 may also show a list of participants of the meeting, such as attendee list 404. The content of the presentation comprising slides is displayed to participants in projector area 406.

While participants are viewing the presentation slides, a variety of simple entertainment activities may be provided to the collaboration participants in order to maintain the participants' interest in the presentation. For example, in a learning environment for young children, entertainment activities in the form of simple games or learning tools may be used to keep the students' attention on the presentation long enough to make a point. Simple entertainment activities may include activities for a single participant, as well as activities that allow multiple collaboration participants to interact with each other during the presentation.

The example in FIG. 4 illustrates a game that may be played by a single participant. In this game, one or more fast moving items, such as insects 408 and 410, is displayed as part of online collaboration display 400 of a particular participant, but in the foreground of the display. The items may move throughout the participant's display and travel in random patterns. The participant may follow and “catch” the items by using the mouse to click on each item.

Other games displayed as part of online collaboration client display 400, such as, for example, ping pong or tennis, may allow multiple participants to interact with one another while maintaining interest in the online collaboration. These multiple participant games are displayed in the online collaboration client display of all of the participants taking part in the activity. The mechanism of the present invention may also allow participants to select the particular entertainment activity used to keep the participant engaged in the collaboration. Users may also participate in group competitions, such as online voting. When a user is requested to submit a response to a question or comment, for example, the participant that submits the first response may win a prize. In this manner, participants may stay focused on the presentation in order to be able to quickly respond to a comment or question. Although the examples in FIG. 4 describe particular simple entertainment activities, it should be noted that any simple entertainment activity for maintaining participant attention on the online collaboration presentation display may be used without departing from the spirit and scope of the present invention.

FIG. 5 is a flowchart of a process for improving participant attentiveness in an online collaboration using interactive tasks in the form of simple entertainment activities in accordance with an illustrative embodiment of the present invention. The process described in FIG. 5 may be implemented in a client collaboration application, such as collaboration applications 304-308 in FIG. 3.

The process begins when a request is received from a participant to join an online collaboration meeting (step 502). After the participant has joined the meeting, the participant may select a particular simple entertainment activity to be used to engage the participant's attention to the meeting (step 504). The participant may select a solo activity, or an activity that requires participant of others in the meeting. The participant may also select attributes for the entertainment activity, such as the speed of the activity, the colors used, etc. The collaboration application then presents the selected entertainment activity to the participant (step 506). The participant may interact with the collaboration application by engaging in the simple entertainment activity, such that the participant's attention is maintained on the collaboration meeting (step 508).

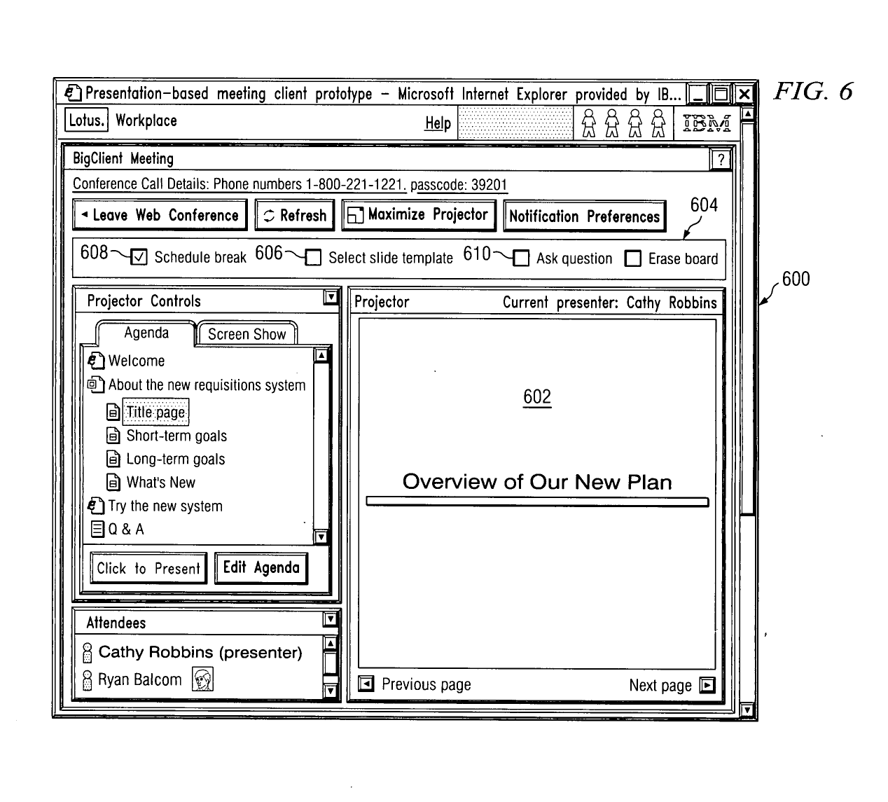

FIG. 6 is an example online collaboration display providing interactive tasks to collaboration participants to enhance the participants' meeting experience in accordance with an illustrative embodiment of the present invention. The online collaboration display in FIG. 6 may be provided to a user via a collaboration application, such as client collaboration applications 304-308 in FIG. 3, within a data processing system, such as clients 110-114 in FIG. 1.

In this illustrative example, participants are presented with online collaboration display 600 comprising a presentation-based meeting. In addition to allowing a user to view a presentation, such as presentation 602, online collaboration display 600 allows users to select interactive tasks which are complementary to the online meeting. Participants may perform various tasks to augment the experience of the participants by giving participants the ability to control the structure or flow of the presentation. As shown, a participant is provided with various interactive tasks 604 from which to define the structure of the collaboration.

For example, the participant may select the template to be used as the background for the presentation slides, erase the presentation electronic whiteboard, determine when a break in the meeting should occur, ask a question, etc. When a participant selects one of the tasks, an input screen such as a popup window may be displayed to the participant that allows the participant to further define the task. For example, if the participant wants to define the presentation slide templates to be used, the participant may check the Select Slide Template checkbox 606. A popup window is then provided to the participant that displays all the available templates that may be used. The participant may select the desired template to be used in the presentation, and the background of the presentation slides as displayed to that participant is updated to reflect the selection. Likewise, if the participant wants to schedule a break, the participant may check the Schedule Break checkbox 608 and define in a popup window the time the participant desires a break in the meeting. In another example, if the participant selects Ask a Question checkbox 610, the participant may input a question in a popup window and submit the question to the presenter.

It should be noted that mechanism of the present invention is not limited to the particular interactive tasks shown in online collaboration display 600, but that other interactive tasks may also be provided to and selected by collaboration participants for enhancing the participants' meeting experience.

FIG. 7 is a flowchart of a process for improving participant attentiveness in an online collaboration using interactive tasks in accordance with an illustrative embodiment of the present invention. The process described in FIG. 7 may be implemented in a client collaboration application, such as collaboration applications 304-308 in FIG. 3.

The process begins when a request is received from a participant to join an online collaboration meeting (step 702). After the participant has joined the meeting, the participant may select a particular interactive task in the online collaboration (step 704). The interactive tasks may be used by the participants to enhance their collaboration experience. Responsive to receiving input from a participant in the form of an interactive task, the structure of the collaboration, such as the presentation template display or when the breaks are scheduled, is updated according to the participant input received (step 706).

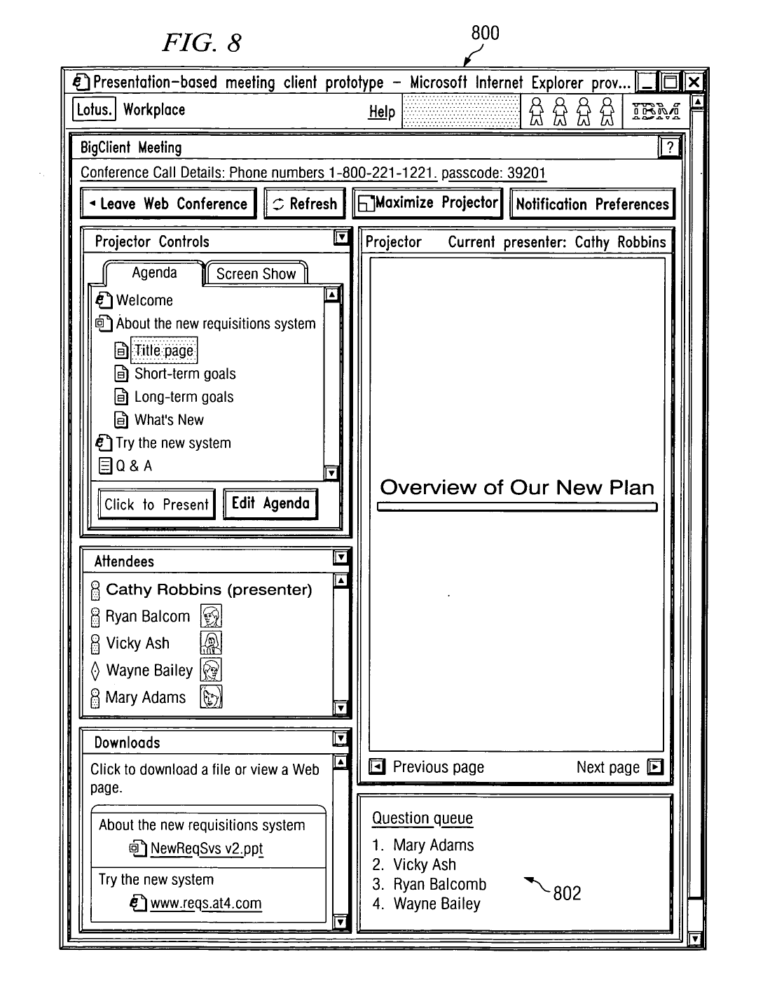

FIG. 8 is an online collaboration display illustrating an example adaptive question queue in accordance with an illustrative embodiment of the present invention. The adaptive question queue may be particularly useful in an enterprise system or large-scale environment. The online collaboration display in FIG. 8 may be provided to a user via a collaboration application, such as client collaboration applications 304-308 in FIG. 3, within a data processing system, such as clients 110-114 in FIG. 1.

Online collaboration display 800 in FIG. 8 allows a participant to view the level of the participant's interaction in the meeting in comparison with others, and the current queue order of questions that have been submitted to the presenter.

Prior to the beginning of or during the collaboration meeting, participants may submit questions to the presenter. For example, a participant may send questions to the presenter prior to the meeting via email on instant messaging, or during the meeting by selecting Ask a Question checkbox 610 in FIG. 6, and the questions are placed in a question queue. In addition, a participant may submit a “marked up” version of the collaboration presentation prior to or during the meeting. For example, in a PowerPoint presentation, a participant may insert comments and questions in the form of “yellow notes” onto the presentation slides. When the marked up version is received, the mechanism of the presentation may parse out the inserted comments and questions and place them in the question queue.

Regardless of the method used to submit the questions, the questions are initially placed in the order in which they are received, and displayed to each participant in queue order display 802. After the meeting begins, the mechanism of the present invention may re-order the questions in the question queue according to the level of interaction of each participant who submitted a question. In one example, questions in the queue may be re-ordered based on how many questions a participant has answered in the meeting. Thus, if a participant has answered the most questions, the questions submitted by that participant may be moved to the top of the queue.

As the questions are re-ordered, participants may track the current order of their questions in queue order display 802. Queue order display 802 on the client computer may be refreshed by the participants at will, or alternatively, the display may automatically be refreshed periodically, using predetermined intervals. As the collaboration display may be refreshed frequently to show participants arriving and leaving the meeting, participants “raising” their hands to ask a question, a new slide, etc., the queue order display may be refreshed in a similar manner. Thus, the mechanism used to refresh the display and speed of the refresh may be determined by the particular collaboration application employed.

In one example, participants A, B, and C all submit questions to the collaboration. If, during the meeting, the mechanism determines that participant C is the most active participant, the queue of questions would place participant C's question at the top of the queue, and participant C's question will be answered first. The other remaining questions will be ordered according to the participants' levels of activity. In this manner, if a participant wants his question answered first, it is in the best interest of the participant to pay attention and interact with the collaboration.

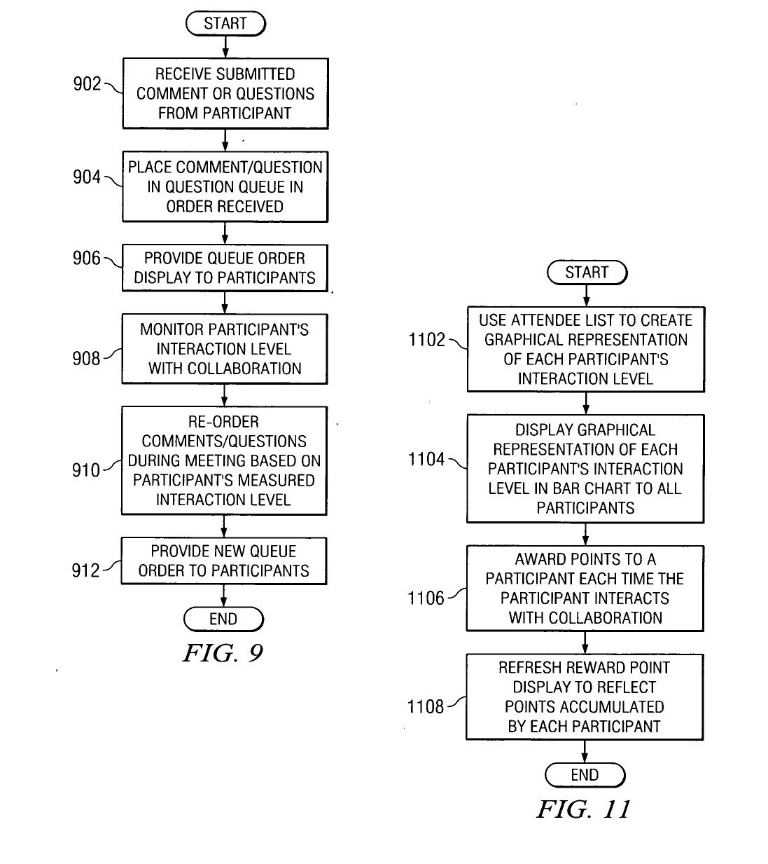

FIG. 9 is a flowchart of a process for improving participation in an online collaboration using an adaptive question queue in accordance with an illustrative embodiment of the present invention. The process described in FIG. 9 may be implemented in a server collaboration application, such as collaboration application 302 in FIG. 3. The adaptive question queue may be stored in memory in the conference server or in a database, such as database 310 in FIG. 3.

The process begins with receiving a submitted comment or question from a participant (step 902). The comment or question is placed in a question queue in the order the comment or question is received (step 904). The question queue illustrating the order in which the comments and questions will be addressed in the meeting is provided to the participants (step 906), such as, for example, within queue order display 802 shown in FIG. 8. During the meeting, the collaboration application on the server may monitor each participant's interaction level with the collaboration (step 908). For instance, the collaboration application on the server may measure how many times each participant has submitted comments to or answered questions in the presentation. The collaboration application may periodically re-order the questions in the queue during the meeting based on each participant's measured interaction level (step 910). The current queue order display is then provided to the participants (step 912), wherein the queue order display on each participant's respective collaboration display is refreshed to reflect the re-ordered question queue.

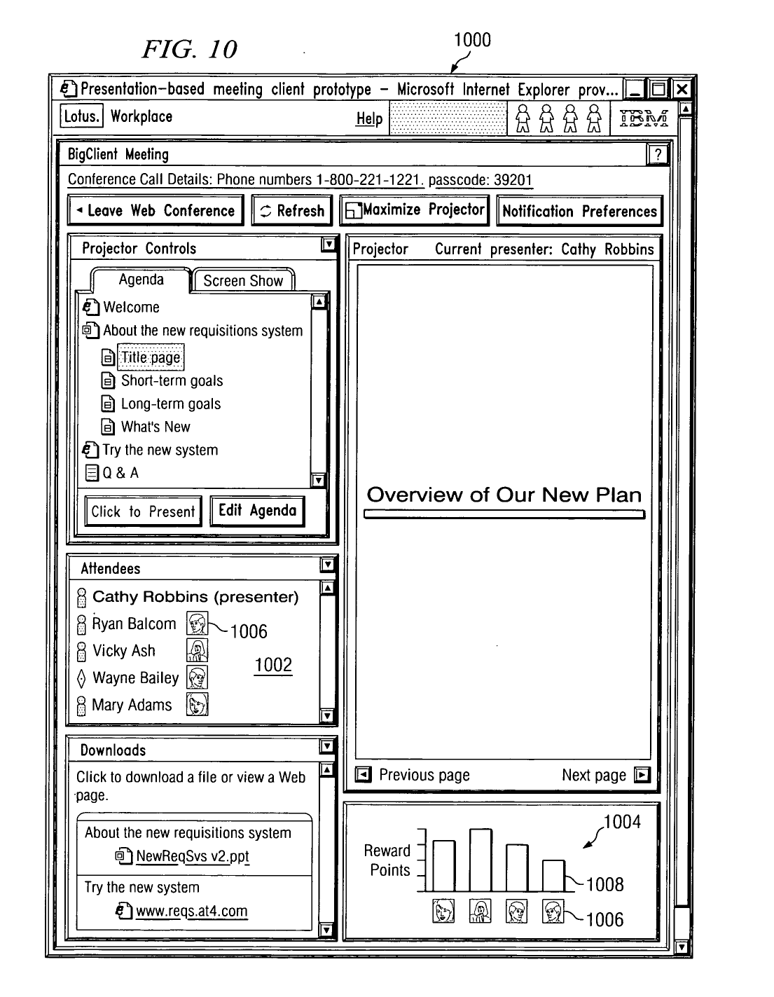

FIG. 10 is an exemplary online collaboration client display illustrating a visual notification of reward points for indicating how many times a user has interacted with the online collaboration in accordance with an illustrative embodiment of the present invention. The online collaboration display in FIG. 4 may be provided to a user via a collaboration application, such as client collaboration applications 304-308 in FIG. 3, within a data processing system, such as-clients 110-114 in FIG. 1.

In this illustrative example, online collaboration client display 1000 depicts a presentation based meeting as viewed by a participant of the meeting. As shown, online collaboration client display 1000 may show a list of participants of the meeting, such as attendee list 1002. Reward points display 1004 is also shown to each participant of the meeting. Reward points display 1004 may comprise a bar chart, wherein each participant of the meeting is represented by the participant's name or a persona icon. As the meeting progresses, each time a participant interacts with the presentation, such as by answering a question, reward points are assigned to the participant. Each participant's reward points are accumulated and shown to all of the meeting participants as a bar in reward points display 1004. Thus, the reward display enables real-time viewing of each participant's accumulated points as the presentation is in progress.

For example, participant Ryan Balcomb 1006 may periodically check reward points display 1004 to compare his performance of accumulating reward points against the performances of other meeting participants. As shown in bar 1008, Ryan Balcomb 1006 has the least number of accumulated reward points. By displaying each participant's reward points to all other participants in the meeting, a participant's focus may be re-directed to online collaboration client display 1000 as the participant periodically checks what his score is in relation to the other participants.

FIG. 11 is a flowchart of a process for improving participation in an online collaboration using visual notification of reward points in accordance with an illustrative embodiment of the present invention. The process described in FIG. 11 may be implemented in a client collaboration application, such as collaboration applications 304-308 in FIG. 3.

The process begins with using the attendee list in the online collaboration display to create a graphical representation of each meeting participant's activity level in the meeting (step 1102). For example, when someone joins the meeting, the participant's name or a persona icon of the participant is displayed in a bar chart, such as reward points bar chart display 1004 in FIG. 10. Each bar in the bar chart is used to represent reward points each participant accumulates through their interaction with the collaboration. This bar chart comprising initial reward point values for the participants is displayed to each participant in the meeting (step 1104). As the meeting progresses, each time a participant interacts with the presentation, such as by answering a question, reward points are assigned to that participant (step 1106). The bar chart reward point display is periodically refreshed to reflect the accumulated points of each participant (step 1108). In this manner, the reward point display enables real-time viewing of each participant's accumulated points as the presentation is in progress. As participants may compare the number of reward points they have accumulated against the other participants throughout the meeting, a participant's focus may be re-directed to online collaboration.

Thus, the mechanism of the present invention provides collaboration participants to control how they may maintain focus on the collaboration presentation, as well as allow participants to augment their experiences of the meeting, such as choosing the template for the presentation to be shown, passing in a marked-up copy of the presentation, and viewing their comments/questions as the comments/questions are queued up for the presenter, specifying when a coffee break should occur, and the like. Thus, the mechanism of the present invention provides ways that participants can maintain their focus on the meeting by allowing participants to interact with the presentation and other participants, and determine the structure of the presentation as well.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for improving participation and attentiveness in an online collaboration environment, comprising:
displaying a collaboration presentation to a user, wherein the collaboration presentation includes a plurality of activities;
receiving a user selection for a desired activity in the plurality of activities; and
providing the desired activity to the user, wherein engaging in the desired activity focuses the user on the collaboration presentation.

2. The computer implemented method of claim 1, wherein providing the desired activity to the user further comprises:
receiving questions from participants, wherein each question is associated with a participant who submitted the question;
placing the questions in a question queue;
monitoring each participant's level of interaction in the online collaboration;
ordering the questions in the question queue based on each participant's level of interaction to form an ordered question queue; and
displaying the ordered question queue to the participants.

3. The computer implemented method of claim 1, wherein providing the desired activity to the user further comprises:
monitoring each participant's activities in the online collaboration;
responsive to determining that a participant has interacted with the online collaboration, assigning points to an activity level of the participant; and
displaying each participant's activity level to all participants in the online collaboration.

4. The computer implemented method of claim 1, wherein the user selection includes a request for an entertainment activity, wherein the entertainment activity is one of a solo entertainment activity or a multi-participant entertainment activity.

5. The computer implemented method of claim 4, wherein the entertainment activity engages user attention without using text.

6. The computer implemented method of claim 1, wherein the user selection defines a structure of the collaboration presentation.

7. The computer implemented method of claim 6, wherein providing the desired activity to the user includes updating the structure of the collaboration presentation.

8. The computer implemented method of claim 6, wherein the user selection defines the structure by one of defining a background to be use in the collaboration presentation, defining a break schedule for the collaboration presentation, or removing presentation material displayed in the collaboration presentation.

9. The computer implemented method of claim 2, wherein the questions are initially placed in the question queue in the order the questions are received.

10. The computer implemented method of claim 2, wherein questions received from participants having a higher level of interaction are ordered higher than questions received from participants having a lower level of interaction.

11. The computer implemented method of claim 2, further comprising:
re-ordering the questions in the question queue to form a reordered question-queue at predetermined intervals during the online collaboration.

12. The computer implemented method of claim 11, further comprising:
refreshing a display of the ordered question queue to reflect the re-ordered question queue, wherein refreshing the display is performed one of upon user request or automatically at predetermined intervals during the online collaboration.

13. The computer implemented method of claim 2, wherein the participant's interaction level is measured based on at least one of the number of questions comments received by the participant or the number of questions the participant has previously answered.

14. The computer implemented method of claim 3, further comprising:
refreshing a display of each participant's activity level to reflect points accumulated during the online collaboration.

15. The computer implemented method of claim 3, wherein each participant's activity level is displayed as a graphical representation.

16. The computer implemented method of claim 3, wherein points are assigned to the participant when the participant answers a question.

17. A data processing system for improving participation and attentiveness in an online collaboration environment, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to display a collaboration presentation to a user, wherein the collaboration presentation includes a plurality of activities, receive a user selection for a desired activity in the plurality of activities, and provide the desired activity to the user, wherein engaging in the desired activity focuses the user on the collaboration presentation.

18. A computer program product for improving participation and attentiveness in an online collaboration environment, the computer program product comprising:
a computer usable medium having computer usable program code tangibly embodied thereon, the computer usable program code comprising:
computer usable program code for displaying a collaboration presentation to a user, wherein the collaboration presentation-includes a plurality of activities;
computer usable program code for receiving a user selection for a desired activity in the plurality of activities; and
computer usable program code for providing the desired activity to the user, wherein engaging in the desired activity focuses the user on the collaboration presentation.

19. The computer program product of claim 18, wherein the computer usable program code for providing the desired activity to the user further comprises:
computer usable program code for receiving questions from participants, wherein each question is associated with a participant who submitted the question;
computer usable program code for placing the questions in a question queue;
computer usable program code for monitoring each participant's level of interaction in the online collaboration;
computer usable program code for ordering the questions in the question queue based on each participant's level of interaction to form an ordered question queue; and
computer usable program code for displaying the ordered question queue to the participants.

20. The computer program product of claim 18, wherein the computer usable program code for providing the desired activity to the user further comprises:
computer usable program code for monitoring each participant's activities in the online collaboration;
computer usable program code for responsive to determining that a participant has interacted with the online collaboration, assigning points to an activity level of the participant; and
computer usable program code for displaying each participant's activity level to all participants in the online collaboration.
